(19) United States
(12) Patent Application Publication
(10) Pub. No.: US 2021/0241565 A1
(43) Pub. Date: Aug. 5, 2021

(54) WAGER ODDS ON PLAYER SENSOR DATA

(71) Applicant: AdrenalineIP, Washington, DC (US)

(72) Inventors: Casey Alexander HUKE, Washington, DC (US); John CRONIN, Jericho, VT (US); Joseph BODKIN, Quincy, MA (US)

(73) Assignee: AdrenalineIP, Washington, DC (US)

(21) Appl. No.: 17/079,867

(22) Filed: Oct. 26, 2020

Related U.S. Application Data
(60) Provisional application No. 62/970,279, filed on Feb. 5, 2020.

(51) Int. Cl. G07F 17/32; G06Q 50/34

(52) U.S. Cl. CPC G07F 17/323; G06Q 50/34; G07F 17/3288

(57) ABSTRACT

A system involving analytics and collecting sensor data in real time. This system allows players to predict and wager on players actions during the course of a play that has yet to occur by collecting sensor data on the players to create a historical database. Utilizing an algorithm, the wagering odds may be provided to the users of the platform to place wagers on the upcoming play betting on the player's sensor data that is collected during the play. The algorithm may determine the probability of the outcome of the player's sensor data and these probabilities of the outcome allow users to determine if the player will exceed or not reach the potential outcome.

### FIELD

The embodiments are generally related to wagers in sports or athletics that are focused on player's sensor data.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

Currently sport betting platforms offer proposition bets or proposition wagers for individuals and teams competing in an event. These “prop bets” are focused on the player's or team's statistics that are gathered and collected over the course of the event. However, these proposition bets are limited to the statistics within the sport or event and have little to do with some of the athletic feats that the athletes perform over the course of an event. Sports fan usually debate the athlete's skill and performance so there is strong interest in the athlete as well as the final game outcomes.

### SUMMARY

The embodiments relate to methods, systems, and apparatuses for collecting data and utilizing it in a wagering game. One embodiment includes a system for live sporting event wagering that can have a plurality of sensors, a platform, and a user device, where the plurality of sensors capture sensor data from a live event, the platform receives and stores the captured data from the plurality of sensors data, filters a historical database containing data related to similar situations in the live event, and determines a most likely outcome associated with each player's sensor data, and the probability of the most likely outcome is sent to the user device to receive a wager.

Another exemplary embodiment can describe a method for adjusting odds for wagers in a real time live event wagering game that includes associating one or more sensors with at least one of a player and an object used in a live event that is subject to real time wagering; collecting data from the one or more sensors; transmitting the data from the one or more sensors to a platform; determining odds on one or more real time wagers in the live event based on a comparison of data in a historical database; adjusting the odds based upon the collected data from the one or more sensors; and outputting a wager with the adjusted odds to the live event wagering game.

Another exemplary embodiment includes a computer implemented method for providing a game program using game information, including executing on a processor the steps of displaying a wagering platform; displaying one or more live events on which wagers may be placed; displaying indicia that indicates sensor data is captured in the one or more live events; displaying one or more real time wagers for a live event; displaying information about a play in the live event; and displaying results of a wager from the one or more real time wagers.

### BRIEF DESCRIPTIONS OF THE DRAWINGS

The accompanying drawings illustrate various embodiments of systems, methods, and embodiments of various other aspects of the disclosure. Any person with ordinary skills in the art will appreciate that the illustrated element boundaries (e.g. boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 illustrates sensor wagers, according to an embodiment.

FIG. 2 illustrates an action module, according to an embodiment.

FIG. 3 illustrates an action database, according to an embodiment.

FIG. 4 illustrates a data collection module, according to an embodiment.

FIG. 5 illustrates a historical sensor database, according to an embodiment.

FIG. 6 illustrates a sensor wager module, according to an embodiment.

FIG. 7 illustrates a wager database, according to an embodiment.

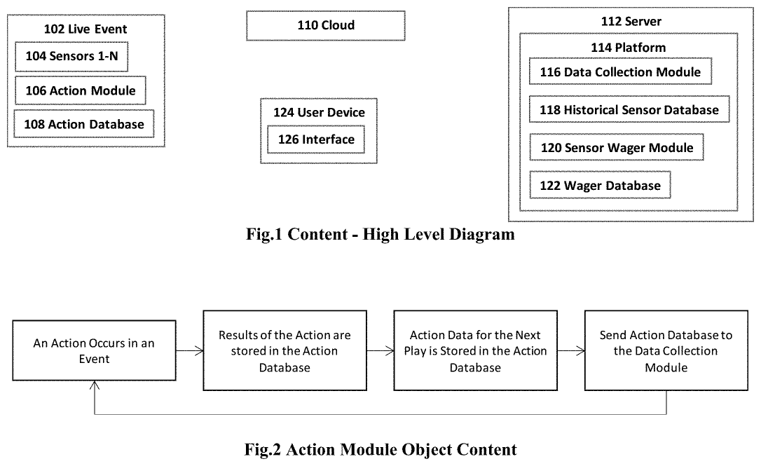

### DETAILED DESCRIPTION

Aspects of the present invention are disclosed in the following description and related figures directed to specific embodiments of the invention. Those of ordinary skill in the art will recognize that alternate embodiments may be devised without departing from the spirit or the scope of the claims. Additionally, well-known elements of exemplary embodiments of the invention will not be described in detail or will be omitted so as not to obscure the relevant details of the invention

As used herein, the word exemplary means serving as an example, instance or illustration. The embodiments described herein are not limiting, but rather are exemplary only. It should be understood that the described embodiments are not necessarily to be construed as preferred or advantageous over other embodiments. Moreover, the terms embodiments of the invention, embodiments or invention do not require that all embodiments of the invention include the discussed feature, advantage, or mode of operation.

Further, many of the embodiments described herein are described in terms of sequences of actions to be performed by, for example, elements of a computing device. It should be recognized by those skilled in the art that the various sequence of actions described herein can be performed by specific circuits (e.g., application specific integrated circuits (ASICs)) and/or by program instructions executed by at least one processor. Additionally, the sequence of actions described herein can be embodied entirely within any form of computer-readable storage medium such that execution of the sequence of actions enables the processor to perform the functionality described herein. Thus, the various aspects of the present invention may be embodied in a number of different forms, all of which have been contemplated to be within the scope of the claimed subject matter. In addition, for each of the embodiments described herein, the corresponding form of any such embodiments may be described herein as, for example, a computer configured to perform the described action.

With respect to the embodiments, a summary of terminology used herein is provided.

An action refers to a specific play or specific movement in a sporting event. For example, an action may determine which players were involved during a sporting event. In some embodiments, an action may be a throw, shot, pass, swing, kick, hit, performed by a participant in a sporting event. In some embodiments, an action may be a strategic decision made by a participant in the sporting event such as a player, coach, management, etc. In some embodiments, an action may be a penalty, foul, or type of infraction occurring in a sporting event. In some embodiments, an action may include the participants of the sporting event. In some embodiments, an action may include beginning events of sporting event, for example opening tips, coin flips, opening pitch, national anthem singers, etc. In some embodiments, a sporting event may be football, hockey, basketball, baseball, golf, tennis, soccer, cricket, rugby, MMA, boxing, swimming, skiing, snowboarding, horse racing, car racing, boat racing, cycling, wrestling, Olympic sport, eSports, etc. Actions can be integrated into the embodiments in a variety of manners.

A “bet” or “wager” is to risk something, usually a sum of money, against someone else's or an entity on the basis of the outcome of a future event, such as the results of a game or event. It may be understood that non-monetary items may be the subject of a “bet” or “wager” as well, such as points or anything else that can be quantified for a “wager” or “bet.” A bettor refers to a person who bets or wagers. A bettor may also be referred to as a user, client, or participant throughout the present invention. A “bet” or “wager” could be made for obtaining or risking a coupon or some enhancements to the sporting event, such as better seats, VIP treatment, etc. A “bet” or “wager” can be done for certain amount or for a future time. A “bet” or “wager” can be done for being able to answer a question correctly. A “bet” or “wager” can be done within a certain period of time. A “bet” or “wager” can be integrated into the embodiments in a variety of manners.

A “book” or “sportsbook” refers to a physical establishment that accepts bets on the outcome of sporting events. A “book” or “sportsbook” system enables a human working with a computer to interact, according to set of both implicit and explicit rules, in an electronically powered domain for the purpose of placing bets on the outcome of sporting event. An added game refers to an event not part of the typical menu of wagering offerings, often posted as an accommodation to patrons. A “book” or “sportsbook” can be integrated into the embodiments in a variety of manners.

To “buy points” means a player pays an additional price (more money) to receive a half-point or more in the player's favor on a point spread game. Buying points means you can move a point spread, for example up to two points in your favor. “Buy points” can be integrated into the embodiments in a variety of manners.

The “price” refers to the odds or point spread of an event. To “take the price” means betting the underdog and receiving its advantage in the point spread. “Price” can be integrated into the embodiments in a variety of manners.

“No action” means a wager in which no money is lost or won, and the original bet amount is refunded. “No action” can be integrated into the embodiments in a variety of manners.

The “sides” are the two teams or individuals participating in an event: the underdog and the favorite. The term “favorite” refers to the team considered most likely to win an event or game. The “chalk” refers to a favorite, usually a heavy favorite. Bettors who like to bet big favorites are referred to “chalk eaters” (often a derogatory term). An event or game in which the sports book has reduced its betting limits, usually because of weather or the uncertain status of injured players is referred to as a “circled game.” “Laying the points or price” means betting the favorite by giving up points. The term “dog” or “underdog” refers to the team perceived to be most likely to lose an event or game. A “longshot” also refers to a team perceived to be unlikely to win an event or game. “Sides”, “favorite”, “chalk”, “circled game”, “laying the points price”, “dog” and “underdog” can be integrated into the embodiments in a variety of manners.

The “money line” refers to the odds expressed in terms of money. With money odds, whenever there is a minus (−) the player “lays” or is “laying” that amount to win (for example $100); where there is a plus (+) the player wins that amount for every $100 wagered. A “straight bet” refers to an individual wager on a game or event that will be determined by a point spread or money line. The term “straight-up” means winning the game without any regard to the “point spread”; a “money-line” bet. “Money line”, “straight bet”, “straight-up” can be integrated into the embodiments in a variety of manners.

The “line” refers to the current odds or point spread on a particular event or game. The “point spread” refers to the margin of points in which the favored team must win an event by to “cover the spread.” To “cover” means winning by more than the “point spread”. A handicap of the “point spread” value is given to the favorite team so bettors can choose sides at equal odds. “Cover the spread” means that a favorite win an event with the handicap considered or the underdog wins with additional points. To “push” refers to when the event or game ends with no winner or loser for wagering purposes, a tie for wagering purposes. A “tie” is a wager in which no money is lost or won because the teams' scores were equal to the number of points in the given “point spread”. The “opening line” means the earliest line posted for a particular sporting event or game. The term “pick” or “pick 'em” refers to a game when neither team is favored in an event or game. “Line”, “cover the spread”, “cover”, “tie”, “pick” and “pick-em” can be integrated into the embodiments in a variety of manners.

To “middle” means to win both sides of a game; wagering on the “underdog” at one point spread and the favorite at a different point spread and winning both sides. For example, if the player bets the underdog +4½ and the favorite −3½ and the favorite wins by 4, the player has middled the book and won both bets. “Middle” can be integrated into the embodiments in a variety of manners.

Digital gaming refers to any type of electronic environment that can be controlled or manipulated by a human user for entertainment purposes. A system that enables a human and a computer to interact according to set of both implicit and explicit rules, in an electronically powered domain for the purpose of recreation or instruction. “eSports” refers to a form of sports competition using video games, or a multiplayer video game played competitively for spectators, typically by professional gamers. Digital gaming and “eSports” can be integrated into the embodiments in a variety of manners.

The term event refers to a form of play, sport, contest, or game, especially one played according to rules and decided by skill, strength, or luck. In some embodiments, an event may be football, hockey, basketball, baseball, golf, tennis, soccer, cricket, rugby, MMA, boxing, swimming, skiing, snowboarding, horse racing, car racing, boat racing, cycling, wrestling, Olympic sport, etc. Event can be integrated into the embodiments in a variety of manners.

The “total” is the combined number of runs, points or goals scored by both teams during the game, including overtime. The “over” refers to a sports bet in which the player wagers that the combined point total of two teams will be more than a specified total. The “under” refers to bets that the total points scored by two teams will be less than a certain figure. “Total”, “over”, and “under” can be integrated into the embodiments in a variety of manners.

A “parlay” is a single bet that links together two or more wagers; to win the bet, the player must win all the wagers in the “parlay”. If the player loses one wager, the player loses the entire bet. However, if he wins all the wagers in the “parlay”, the player wins a higher payoff than if the player had placed the bets separately. A “round robin” is a series of parlays. A “teaser” is a type of parlay in which the point spread, or total of each individual play is adjusted. The price of moving the point spread (teasing) is lower payoff odds on winning wagers. “Parlay”, “round robin”, “teaser” can be integrated into the embodiments in a variety of manners.

A “prop bet” or “proposition bet” means a bet that focuses on the outcome of events within a given game. Props are often offered on marquee games of great interest. These include Sunday and Monday night pro football games, various high-profile college football games, major college bowl games and playoff and championship games. An example of a prop bet is “Which team will score the first touchdown?” “Prop bet” or “proposition bet” can be integrated into the embodiments in a variety of manners.

A “first-half bet” refers to a bet placed on the score in the first half of the event only and only considers the first half of the game or event. The process in which you go about placing this bet is the same process that you would use to place a full game bet, but as previously mentioned, only the first half is important to a first-half bet type of wager. A “half-time bet” refers to a bet placed on scoring in the second half of a game or event only. “First-half-bet” and “half-time-bet” can be integrated into the embodiments in a variety of manners.

A “futures bet” or “future” refers to the odds that are posted well in advance on the winner of major events, typical future bets are the Pro Football Championship, Collegiate Football Championship, the Pro Basketball Championship, the Collegiate Basketball Championship, and the Pro Baseball Championship. “Futures bet” or “future” can be integrated into the embodiments in a variety of manners.

The “listed pitchers” is specific to a baseball bet placed only if both of the pitchers scheduled to start a game actually start. If they don't, the bet is deemed “no action” and refunded. The “run line” in baseball, refers to a spread used instead of the money line. “Listed pitchers” and “no action” and “run line” can be integrated into the embodiments in a variety of manners.

The term “handle” refers to the total amount of bets taken. The term “hold” refers to the percentage the house wins. The term “juice” refers to the bookmaker's commission, most commonly the 11 to 10 bettors lay on straight point spread wagers: also known as “vigorish” or “vig”. The “limit” refers to the maximum amount accepted by the house before the odds and/or point spread are changed. “Off the board” refers to a game in which no bets are being accepted. “Handle”, “juice”, vigorish”, “vig” and “off the board” can be integrated into the embodiments in a variety of manners.

“Casinos” are a public room or building where gambling games are played. “Racino” is a building complex or grounds having a racetrack and gambling facilities for playing slot machines, blackjack, roulette, etc. “Casino” and “Racino” can be integrated into the embodiments in a variety of manners.

Customers are companies, organizations or individual that would deploy, for fees, and may be part of, of perform, various system elements or method steps in the embodiments.

Managed service user interface service is a service that can help customers (1) manage third parties, (2) develop the web, (3) do data analytics, (4) connect thru application program interfaces and (4) track and report on player behaviors. A managed service user interface can be integrated into the embodiments in a variety of manners.

Managed service risk management services are a service that assists customers with (1) very important person management, (2) business intelligence, and (3) reporting. These managed service risk management services can be integrated into the embodiments in a variety of manners.

Managed service compliance service is a service that helps customers manage (1) integrity monitoring, (2) play safety, (3) responsible gambling and (4) customer service assistance. These managed service compliance services can be integrated into the embodiments in a variety of manners.

Managed service pricing and trading service is a service that helps customers with (1) official data feeds, (2) data visualization and (3) land based, on property digital signage. These managed service pricing and trading services can be integrated into the embodiments in a variety of manners.

Managed service and technology platform are services that helps customers with (1) web hosting, (2) IT support and (3) player account platform support. These managed service and technology platform services can be integrated into the embodiments in a variety of manners.

Managed service and marketing support services are services that help customers (1) acquire and retain clients and users, (2) provide for bonusing options and (3) develop press release content generation. These managed service and marketing support services can be integrated into the embodiments in a variety of manners.

Payment processing services are those services that help customers that allow for (1) account auditing and (2) withdrawal processing to meet standards for speed and accuracy. Further, these services can provide for integration of global and local payment methods. These payment processing services can be integrated into the embodiments in a variety of manners.

Engaging promotions allow customers to treat your players to free bets, odds boosts, enhanced access and flexible cashback to boost lifetime value. Engaging promotions can be integrated into the embodiments in a variety of manners.

“Cash out” or “pay out” or “payout” allow customers to make available, on singles bets or accumulated bets with a partial cash out where each operator can control payouts by managing commission and availability at all times. The “cash out” or “pay out” or “payout” can be integrated into the embodiments in a variety of manners, including both monetary and non-monetary payouts, such as points, prizes, promotional or discount codes, and the like.

“Customized betting” allow customers to have tailored personalized betting experiences with sophisticated tracking and analysis of players' behavior. “Customized betting” can be integrated into the embodiments in a variety of manners.

Kiosks are devices that offer interactions with customers clients and users with a wide range of modular solutions for both retail and online sports gaming. Kiosks can be integrated into the embodiments in a variety of manners.

Business Applications are an integrated suite of tools for customers to manage the everyday activities that drive sales, profit, and growth, from creating and delivering actionable insights on performance to help customers to manage the sports gaming. Business Applications can be integrated into the embodiments in a variety of manners.

State based integration allows for a given sports gambling game to be modified by states in the United States or countries, based upon the state the player is in, based upon mobile phone or other geolocation identification means. State based integration can be integrated into the embodiments in a variety of manners.

Game Configurator allow for configuration of customer operators to have the opportunity to apply various chosen or newly created business rules on the game as well as to parametrize risk management. Game configurator can be integrated into the embodiments in a variety of manners.

“Fantasy sports connector” are software connectors between method steps or system elements in the embodiments that can integrate fantasy sports. Fantasy sports allow a competition in which participants select imaginary teams from among the players in a league and score points according to the actual performance of their players. For example, if a player in a fantasy sports is playing at a given real time sports, odds could be changed in the real time sports for that player.

Software as a service (or SaaS) is a method of software delivery and licensing in which software is accessed online via a subscription, rather than bought and installed on individual computers. Software as a service can be integrated into the embodiments in a variety of manners.

Synchronization of screens means synchronizing bets and results between devices, such as TV and mobile, PC and wearables. Synchronization of screens can be integrated into the embodiments in a variety of manners.

Automatic content recognition (ACR) is an identification technology to recognize content played on a media device or present in a media file. Devices containing ACR support enable users to quickly obtain additional information about the content they see without any user-based input or search efforts. To start the recognition, a short media clip (audio, video, or both) is selected. This clip could be selected from within a media file or recorded by a device. Through algorithms such as fingerprinting, information from the actual perceptual content is taken and compared to a database of reference fingerprints, each reference fingerprint corresponding to a known recorded work. A database may contain metadata about the work and associated information, including complementary media. If the fingerprint of the media clip is matched, the identification software returns the corresponding metadata to the client application. For example, during an in-play sports game a “fumble” could be recognized and at the time stamp of the event, metadata such as “fumble” could be displayed. Automatic content recognition (ACR) can be integrated into the embodiments in a variety of manners.

Joining social media means connecting an in-play sports game bet or result to a social media connection, such as a FACEBOOK® chat interaction. Joining social media can be integrated into the embodiments in a variety of manners.

Augmented reality means a technology that superimposes a computer-generated image on a user's view of the real world, thus providing a composite view. In an example of this invention, a real time view of the game can be seen and a “bet” which is a computer-generated data point is placed above the player that is bet on. Augmented reality can be integrated into the embodiments in a variety of manners.

Some embodiments of this disclosure, illustrating all its features, will now be discussed in detail. It can be understood that the embodiments are intended to be open ended in that an item or items used in the embodiments is not meant to be an exhaustive listing of such item or items, or meant to be limited to only the listed item or items.

It can be noted that as used herein and in the appended claims, the singular forms “a,” “an,” and “the” include plural references unless the context clearly dictates otherwise. Although any systems and methods similar or equivalent to those described herein can be used in the practice or testing of embodiments, only some exemplary systems and methods are now described.

Generally provided are methods and systems for sensor wagers. This system includes of live event 102, for example a sporting event such as a football game, basketball game, baseball game, hockey game, tennis match, golf tournament, etc. The live event will include some number of actions or plays, upon with a user or bettor or customer can place a bet or wager, typically through an entity called a sportsbook. There are numerous types of wagers the bettor can make, including, a straight bet, a money line bet, a bet with a point spread or line that bettor's team would need to cover, if the result of the game with the same as the point spread the user would not cover the spread, but instead the tie is called a push. If the user is betting on the favorite, they are giving points to the opposing side, which is the underdog or longshot. Betting on all favorites is referred to as chalk, this is typically applied to round robin, or other styles of tournaments. There are other types of wagers, including parlays, teasers and prop bets, that are added games, that often allow the user to customize their betting, by changing the odds and payouts they receive on a wager. Certain sportsbooks will allow the bettor to buy points, to move the point spread off of the opening line, this will increase the price of the bet, sometimes by increasing the juice, vig, or hold that the sportsbook takes. Another type of wager the bettor can make is an over/under, in which the user bets over or under a total for the live event, such as the score of American football or the run line in baseball, or a series of action in the live event. Sportsbooks have an amount of bets they can handle, a limit of wagers they can take on either side of a bet before they will move the line or odds off of the opening line. Additionally, there are circumstance, such as an injury to an important player such as a listed pitcher, in which a sportsbook, casino or racino will take an available wager off the board. As the line moves there becomes an opportunity for a bettor to bet on both sides at different point spreads in order to middle and win both bets. Sportsbooks will often offer bets on portions of games, such as first half bets and half time bets. Additionally, the sportsbook can offer futures bets on live events in the future. Sportsbooks need to offer payment processing services in order to cash out customers. This can be done at kiosks at the live event or at another location, element 102. The system may include a plurality of sensors 104 that may be used such as motion sensors, temperature sensors, humidity sensors, cameras such as an RGB-D Camera which is a digital camera providing color (RGB) and depth information for every pixel in an image, microphones, radiofrequency receiver, a thermal imager, a radar device, a lidar device, an ultrasound device, a speaker, wearable devices etc. Also, the plurality of sensors may include tracking devices, such as RFID tags, GPS chips or other such devices embedded on uniforms, in equipment, in the field of play, in the boundaries of the field of play, or other markers on the field of play. Imaging devices may also be used as tracking devices such as player tracking that provides statistical information through real-time X, Y positioning of players and X, Y, Z positioning of the ball.

The system may include an action module 106, which is continuously polling the various sensors available during a live event to determine which sensors are available and collect the sensor data and store the data in the action database, element 106. The system may include an action database 108, which stores the sensor data from the plurality of sensors available during a live event, element 108. The system also includes a cloud 110 or communication network may be a wired and/or a wireless network. The communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort, often over Internet and relies on sharing of resources to achieve coherence and economies of scale, like a public utility, while third-party clouds enable organizations to focus on their core businesses instead of expending resources on computer infrastructure and maintenance. The cloud may be communicatively coupled to server 112 which may perform real time analysis on the type of play and the result of the play. The cloud may also be synchronized with game situational data, such as the time of the game, the score, location on the field, weather conditions, and the like which may affect the choice of play utilized. For example, in other exemplary embodiments, the cloud may not receive data gathered from sensors and may, instead, receive data from an alternative data feed, such as SportsRadar. This data may be provided substantially immediately following the completion of any play and the data from this feed may be compared with a variety of team data and league data based on a variety of elements, including down, possession, score, time, team, and so forth, as described in various exemplary embodiments herein, element 110. The system may include a server 112 which may perform real time analysis on the type of play and the result of a play or action. The server 112 (or cloud 110) may also be synchronized with game situational data, such as the time of the game, the score, location on the field, weather conditions, and the like which may affect the choice of play utilized. For example, in other exemplary embodiments, server 112 may not receive data gathered from sensors and may, instead, receive data from an alternative data feed, such as Sports Radar. This data may be provided substantially immediately following the completion of any play and the data from this feed may be compared with a variety of team data and league data based on a variety of elements, including down, possession, score, time, team, and so forth, as described in various exemplary embodiments herein. The server 112 can offer a number of software as a service managed services such as, user interface service, risk management service, compliance, pricing and trading service, IT support of the technology platform, business applications, game configuration, state based integration, fantasy sports connection, integration to allow the joining of social media, as well as marketing support services that can provide engaging promotions to the user.

The system may further include a platform 114 which in some embodiments may be located on a server 112, the cloud 110, or the user device 122. The platform 114 contains the data collection module, the historical sensor database, and the sensor wager module, which are used to collect the sensor data from the live event and store the sensor data in the historical sensor database via the data collection module and provide wager odds to the user via sensor wager module, element 114. The platform may include a data collection module 116, which is continuously polling the live event for the action database which contains sensor data from the live event in order to update the historical sensor database in real time as well as receive the information on the most current play or action within the event, element 116. The platform may include a historical sensor database 118, which contains the historical sensor data from previous live events or sensor data from plays that have previously occurred in a live event, element 118. The platform may also include a sensor wager module 120, which uses the current play information from a live event and the data stored in the historical sensor database to create wagering odds that may be provided to a user, element 120. The platform may also include a wager database 122, which stores the wagers created from the sensor wager module and the sensor wager module provides the wager database to the user device to allow the user to view and place their wagers, element 122. The system may include a user device 124, such as a computing device, laptop, smartphone, tablet, computer, smart speaker, or I/O devices. I/O devices may be present in the computing device. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers. Devices may include a combination of multiple input or output devices, including, e.g., Microsoft KINECT, Nintendo Wiimote for the WIT, Nintendo WII U GAMEPAD, or Apple IPHONE. Some devices allow gesture recognition inputs through combining some of the inputs and outputs. Some devices provide for facial recognition which may be utilized as an input for different purposes including authentication and other commands. Some devices provides for voice recognition and inputs, including, e.g., Microsoft KINECT, SIRI for IPHONE by Apple, Google Now or Google Voice Search.

Additional devices have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices, display devices or group of devices may be augmented reality devices. The I/O devices may be controlled by an I/O controller. The I/O controller may control one or more I/O devices, such as, e.g., a keyboard and a pointing device, e.g., a mouse or optical pen. Furthermore, an I/O device may also provide storage and/or an installation medium for the computing device. In still other embodiments, the computing device may provide USB connections (not shown) to receive handheld USB storage devices. In further embodiments, an I/O device may be a bridge between the system bus and an external communication bus, e.g. a USB bus, a SCSI bus, a FireWire bus, an Ethernet bus, a Gigabit Ethernet bus, a Fibre Channel bus, or a Thunderbolt bus. The user device 124 can leverage the sensors in for purposes such as automatic content recognition, augmented reality or the synchronization of screens between the user device interface and other displays. The user device 124, may include interface(s) 126, which may either accept inputs from users or provide outputs to the users or may perform both the actions. In one case, a user can interact with the interface(s) using one or more user-interactive objects and devices. The user-interactive objects and devices may include user input buttons, switches, knobs, levers, keys, trackballs, touchpads, cameras, microphones, motion sensors, heat sensors, inertial sensors, touch sensors, or a combination of the above. Further, the interface(s) may either be implemented as a Command Line Interface (CLI), a Graphical User Interface (GUI), a voice interface, or a web-based user-interface.

Functioning of an action module will now be explained with reference to FIG. 2. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

This figure displays the action module. The process begins with an action, for example a play, occurs in an event, such as a sporting event. Play data can be any sensor data that indicates anything about the live game, such as , but no limited to audio of visual data that indicates “actions”, “sides”, “event” data, “total” data, “listed pitchers”, specific players, whistles, fouls, touchdowns, goals, yardage, player error, etc., at step 200. The action module then stores the results of the action in the action database, such as events data as score, player, time period etc., at step 202. The action module also stores sensor data in the action database which is information for the upcoming play in an event. For example, sensor data could be yards traveled or speed of an athlete, etc., at step 204. The action module then sends the action database to the data collection module and the process returns to step 200, at step 206. It should be noted that the action module can be made available for access , reconfiguration, modification, or control for “customers” or used for “Managed service user interface service”, “Managed service risk management services”, “Managed service compliance service”, “Managed service pricing and trading service”, “Managed service and technology platform”, “Managed service and marketing support services”, “Payment processing services”, “Engaging promotions”, “Customized betting”, “Business Applications”, “State based integration”, “Game Configurator”, “Fantasy sports connector”, “Software as a service”, “Synchronization of screens”, “Automatic content recognition (ACR)”, “Joining social media”, and “Augmented reality”,

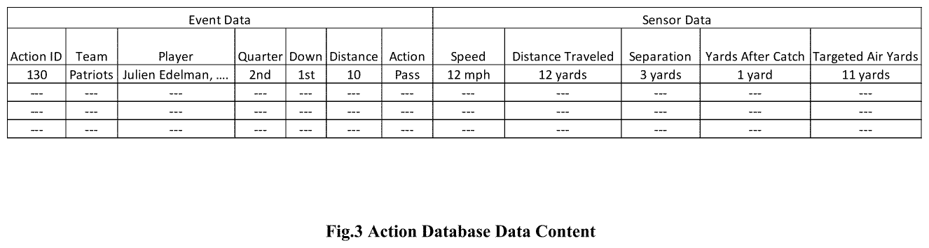

Functioning of an action database will now be explained with reference to FIG. 3. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

This figure displays the action database. The action database stores the sensor data captured from the plurality of sensors available at a live event through the action module. The database may include event data, which is informational data about the action or play that occurred within an event, and sensor data, which is the sensor data collected from the various players or participants involved in the play. The event data may be an action ID or play ID, the team participating in the event, the player, the time period of the action, for example for American football the quarter, down, distance, and the action or play that occurred. The sensor data may be adjusted depending on the event, but for this example of American football the sensor data may be speed which shows the maximum speed, measured in Miles Per Hour (MPH), a player achieves on a given play when carrying the ball on offense (rusher, passer or receiver) or special teams (punt or kick returner). The separation which is the distance (in yards) measured between a WRITE and the nearest defender at the time of catch or incompletion. The yards after catch which are the yards gained after catch by a receiver. The targeted air yards which is the average passing air yards per target for the receiver, by measuring the yards downfield at the time of all passing attempts that the receiver is the target. This stat indicates how far down the field they are being targeted on average. This sensor data may be collected from various types of sensors that the players wear during an event, or through video images in which the players movements are tracked and recorded and in which data can be extracted such as a player's separation from another player, at step 300.

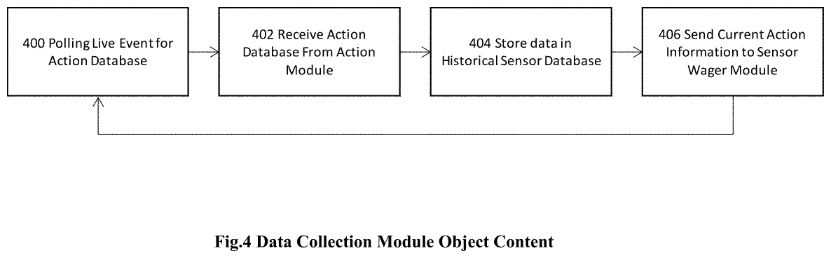

Functioning of the data collection module will now be explained with reference to FIG. 4. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

This figure displays the data collection module. The process begins with the data collection module continuously polling the live event for the action database which contains the recently collected sensor data from a live event, at step 400. The data collection module receives the action database from action module at the live event. In some embodiments, the data collection module may also receive current play information from the live event, participants involved in the previous or upcoming play, coaches involved, etc. In some embodiments, the data collection module may use third party data in order to collect the necessary data as opposed to using data collected directly from a live event, at step 402. The data collection module stores the sensor data received from the action database in the historical sensor database which contains all the historical sensor data collected from previous live events, at step 404. Then the data collection module sends the current play information and the sensor wager module, at step 406.

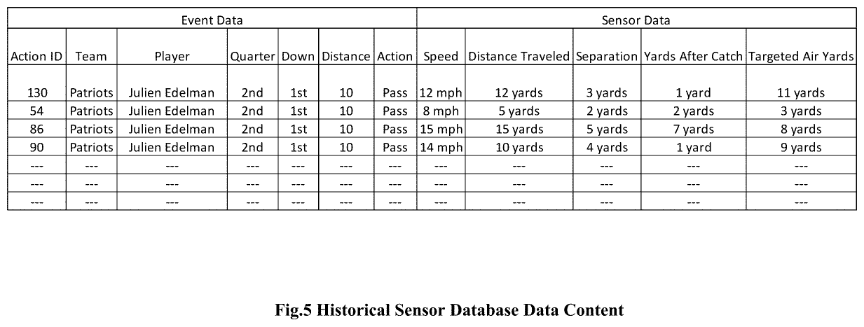

Functioning of the historical sensor database will now be explained with reference to FIG. 5. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

This figure displays the historical sensor database. The historical sensor database stores the sensor data captured from various live events through the data collection module. The database may include event data, which is informational data about the action or play that occurred within an event, and sensor data, which is the sensor data collected from the various players or participants involved in the play. The event data may be an action ID or play ID, the team participating in the event, the player, the time period of the action, for example for American football the quarter, down, distance, and the action or play that occurred. The sensor data may be adjusted depending on the event, but for this example of American football the sensor data may be speed which shows the maximum speed, measured in Miles Per Hour (MPH), a player achieves on a given play when carrying the ball on offense (rusher, passer or receiver) or special teams (punt or kick returner). The separation which is the distance (in yards) measured between a WRITE and the nearest defender at the time of catch or incompletion. The yards after catch which are the yards gained after catch by a receiver. The targeted air yards which is the average passing air yards per target for the receiver, by measuring the yards downfield at the time of all passing attempts that the receiver is the target. This stat indicates how far down the field they are being targeted on average. In this example of the historical sensor database, the database is filtered for wide receiver Julien Edelman as explained in the sensor wager module. The historical sensor database is filtered on the team, the player, the quarter, the down, the distance, and the action. This is to ensure that the averages taken from the sensor data collected are all from similar situations to allow for realistic probabilities for the upcoming play and thus provide fair wagering odds. In some embodiments, the sensor data may be analyzed locally on the sensor itself and the data may be sent directly to the historical database, at step 500.

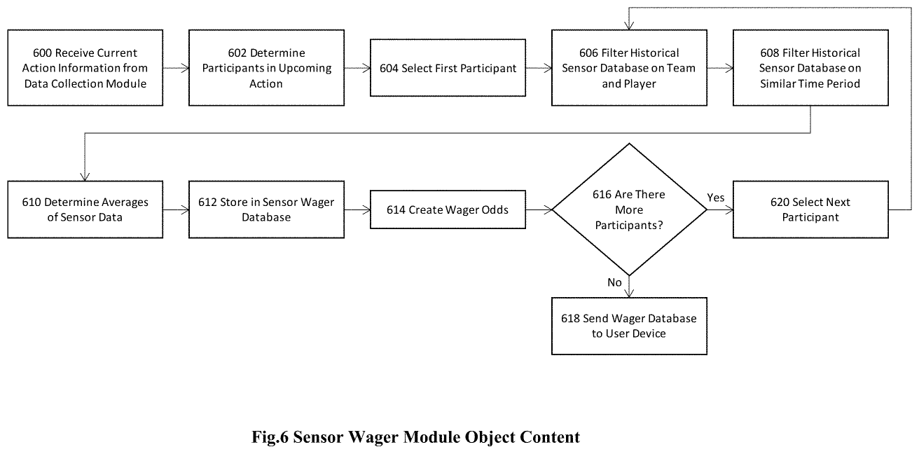

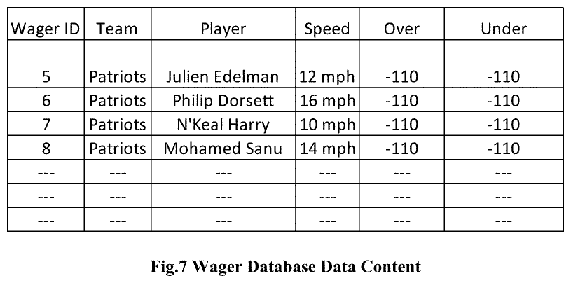

Functioning of the sensor wager module will now be explained with reference to FIG. 6. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

This figure displays the sensor wager module. The process begins with the sensor wager module receives the current action information data, or the information on the upcoming play, from the data collection module, at step 600. Then the sensor wager module determines the participants or the players in the upcoming action or play, at step 602. The sensor wager module selects the first participant for the upcoming play, at step 604. Then the sensor wager module filters the historical sensor database on similar situations, such as filtering on the team and player. In some embodiments, the historical sensor database may also be filtered on similar opposing players, referees, weather conditions, location of the event, time of the event (i.e. night vs. day), field conditions, type of field (i.e. real grass vs. artificial), etc. at step 606. Then the sensor wager module is filtered on the similar times within the event, for example if the upcoming play is in the second quarter of an American football game the historical sensor database would be filtered on plays that occurred in the second quarter of an American football game while incorporating the other discussed filters. In some embodiments, the historical sensor database may also be filtered on similar game situations. For example, in American football if the upcoming play was a first down with 10 yards to gain, the historical sensor database would be filtered on all other plays that occurred on a first down with 10 yards to gain while still incorporating the other discussed filters, at step 608. Then, once all the appropriate filters have been applied, the sensor wager module determines the averages of the available sensor data. For example, in American football a wide receivers average sensor data may be for the player's speed, distance traveled, separation, yards after catch, targeted air yards. These averages would be from similar play situations to the upcoming play in the event, at step 610. The sensor wager module then stores the averages of the sensor data in the sensor wager database, at step 612. The sensor wager module then creates the odds for each of the averages. In this example, the odds created can be for the player's sensor data to be over or under their calculated averages from the historical sensor database. Typically for Over/Under wagers the same odds are provided for both sides of the wager. For example, the historical sensor database shows historical sensor data of wide receiver Julien Edelman and in this collection of historical sensor data his average speed is 12.25 mph's, so the over/under would be 12 mph. The wager that would be available for users would be “Will Julien Edelman's speed on the next play be over or under 12 mph?”. The odds for under 12 mph may be −110 and the odds for over 12 mph may be −110, which are typical odds that provide the user with even side while incorporating the “juice”. In some embodiments, these may be adjusted due to weather conditions, injury statuses, opposing players, etc. Also, in some embodiments, the type of wager may be altered such as “Who will run the fastest on the upcoming play?” and using the data in the historical sensor database the players averages from the collected sensor data may be compared in order to provide odds as to who will run the fastest on the upcoming play, at step 614. The sensor wager module then determines if there are more participants in the event that have not been selected, at step 616. If there are no more participants that need to be selected the sensor wager module sends the wager database to the user devices to allow user to place their wagers on the upcoming play within an event, at step 618. If there are more participants to be selected, the next participant is selected and the process returns to step 606, at step 620. Further, it may be appreciated that, when playing a wagering game, users may be provided with one or more indicia that available games for wagering have odds affected or adjusted using captured sensor data, that sensor data is available to view and utilize in such games, or that the availability or use of sensor data can be toggled on or off, or otherwise activated or deactivated for different wagers, games, events, and the like.

Functioning of the wager database will now be explained with reference to FIG. 2. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

This figure displays the wager database. The wager database is created through the process described in the sensor wager module in which the sensor wager module filters the historical sensor database on specific players and previous plays or actions that have sensor from similar plays or actions and then determines the averages of the historical sensor data, which is then used to create an over/under wager and the data is stored in the wager database. In this example, the wager database is set up for wagers on wide receiver's speeds on the New England Patriots. The database contains the wager ID, the team, the player, the speed used for the over/under and the odds if the user selected over or under. The sensor wager module sends the wager database to the user device for the user to select the desired wager. In some embodiments, the wager database may be for a plurality of other positions in American football, such as quarterbacks and throwing distance, defensive players making a tackle, etc. The database can be created for a plurality of sporting events, such as baseball, basketball, hockey, etc. In some embodiments, the database may include odds for comparing players to other players such as wager odds for: who will catch the ball on this play, who will run the fastest on the next play, who will run the farthest on the next play, who will have the fastest pulse on the next play, etc. In some embodiments, the sensor data may be collected from equipment used in the event or worn by participants. In some embodiments, the wagers for the sensor data gathered from the equipment may be, for example, in baseball an over/under wager on how fast the exit velocity will be on the next home run, or which player will have the fastest exit velocity in the game. Another example would be if in cricket the field was split into quadrants and the user can select which quadrant the next six will occur. This may be accomplished by using a virtual grid to determine which quadrant the ball went out of play. In some embodiments, the virtual grid may also be used to track players movements and position. A virtual grid would require image processing that breaks the field of play into predefined sections of a certain size that would allow for a quick analysis to determine how far and how fast a player moved throughout the field of play as well as track their position, at step 700. Other examples of wager data can be a “Bet” or “wager” or “buy points” or “price” or “no action” or “favorite” or “chalk” or “circled game” or “laying the points price” or “dog” or “underdog” or “money line” or “straight bet” or “straight-up” or Line” or “cover the spread” or “cover “or “tie” or “pick” or “pick-em” or “middle” or “parlay” or “round robin” or “teaser” or “prop bet” or “first-half-bet” or “half-time-bet” or “futures bet” or “future” or “handle” or “juice” or “vigorish” or “off the board”.

1. A system for live sporting event wagering, comprising:
a plurality of sensors,
an automatic content recognition (ACR) system communicatively coupled with an ACR database and configured to compare a plurality of data and/or media files from live events to a plurality of reference fingerprints in the database, and the ACR system is configured to identify at least one matching reference fingerprint from an action in the live events;
a platform, and
a user device,
wherein the plurality of sensors capture sensor data from a live event,
the platform receives and stores the captured data from the plurality of sensors, filters a historical database containing data related to similar situations in the live event and the at least one matching reference fingerprint from the ACR system, and determines a most likely outcome associated with sensor data, and
a probability of the most likely outcome is identified based on the matching reference fingerprint from the ACR system and the sensor data and is sent to the user device to receive a wager.

2. The system of claim 1, wherein the plurality of sensors collect data from at least one of a player and an object used in the live event.

3. The system of claim 1, wherein the plurality of sensors collect physiological data from at least one player in the live event.

4. The system of claim 1, wherein the plurality of sensors collect event data comprising informational data about action that occurred in the live event.

5. The system of claim 1, wherein the plurality of sensors are embedded in a playing surface of the live event.

6. The system of claim 1, further comprising an action module that polls the plurality of sensors to determine at least one of active sensors among the plurality of sensors and sensors with relevant data among the plurality of sensors.

7. The system of claim 1, further comprising an output of odds for a wager on an action in the live event that have been adjusted based on captured sensor data.

8. The system of claim 1, wherein captured sensor data is used to determine if a wager was successful.

9. A method for adjusting odds for wagers in a real time live event wagering game, comprising:
associating one or more sensors with at least one of a player and an object used in a live event that is subject to real time wagering;
comparing a plurality of data and/or media files from live events to a plurality of reference fingerprints in the database with an automatic content recognition (ACR) system, wherein the ACR system is configured to identify at least one matching reference fingerprint from an action in the live events;
collecting data from the one or more sensors;
transmitting the data from the one or more sensors to a platform;
determining odds on one or more real time wagers in the live event based on a comparison of data in a historical database, the historical database including at least one matching reference fingerprint determined by the ACR system;
adjusting the odds based upon the collected data from the one or more sensors; and
outputting a wager with the adjusted odds to the live event wagering game.

10. The method of claim 9, further comprising collecting at least one of physiological data and movement data of a player in the live event from at least one of the one or more sensors.

11. The method of claim 9, further comprising collecting game situational data of the live event with at least one of the one or more sensors.

12. The method of claim 9, further comprising determining which sensors among the one or more sensors are active.

13. The method of claim 9, further comprising determining what data collected from the one or more sensors is relevant to the determined odds.

14. A computer implemented method for providing a game program using game information, comprising executing on a processor the steps of:
displaying a wagering platform;
displaying one or more live events on which wagers may be placed;
displaying indicia that indicates sensor data is captured in the one or more live events and the odds are affected by the captured sensor data;
displaying one or more real time wagers for a live event;
displaying information about a play in the live event; and
displaying results of a wager from the one or more real time wagers.

15. The method of claim 14, further comprising displaying indicia to activate or deactivate adjusting odds for the one or more real time wagers related to the captured sensor data.
